(19) United States
(12) Patent Application Publication
(10) Pub. No.: US 2010/0148557 A1
(43) Pub. Date: Jun. 17, 2010

(54) SWIVELABLE VEHICLE SEAT COMPRISING A LOCKING MEANS FOR CREATING A MANUALLY SURMOUNTABLE RESISTANCE

(76) Inventor: Andreas Schmitz, Burscheid (DE)

Correspondence Address: Johnson Controls, Inc.;c/o Fletcher Yoder PC, P.O. Box 692289, Houston, TX, 77269, US

(21) Appl. No.: 12/442,542

(22) PCT Filed: Apr. 2, 2007
(86) PCT No.: PCT/EP2007/008219

§ 371 Date: Dec. 21, 2009

(30) Foreign Application Priority Data
Sep. 25, 2006 (DE) 10 2006 049 576.2

(51) Int. Cl. B60N 2/20; B60N 2/02

(52) U.S. Cl. 297/362

(57) ABSTRACT

Disclosed is a motor vehicle seat comprising a first mounting part and a second mounting part. The first mounting part can be swiveled relative to the second mounting part about a swivel pin. The vehicle seat further comprises a gear unit which allows the first mounting part to be angularly adjusted relative to the second mounting part. The first mounting part is connected to a backrest of the vehicle seat while the second mounting part is connected to a seat part of the vehicle seat. The backrest of the vehicle seat extends vertically and substantially perpendicular to the seat part in a first position while being swiveled relative to the first position about the swivel pin in a second position. The vehicle seat also comprises a locking means (6) which encompasses at least one locking surface (15, 15′) and causes the first mounting part and the second mounting part to interlock in the second position in such a way that a manually surmountable resistance is created that makes it more difficult to swivel the backrest into the first position. In the second position, the locking surfaces of the locking means are arranged on top of one another, in a radial direction relative to the swivel pin.

### CROSS REFERENCE TO RELATED APPLICATIONS

This application claims priority from and the benefit of PCT Application No. PCT/EP2007/008219, filed on Sep. 21, 2007; and German Patent No. DE 10 2006 049 576.2, filed on Sep. 25, 2006; both entitled “Swiveling Vehicle Seat Comprising a locking Means for Creating a Manually Surmountable Resistance”, which are herein incorporated by reference.

### BACKGROUND

The invention relates to a vehicle seat for a motor vehicle, comprising a first swivelable mounting part and a second mounting part, the first mounting part being able to be angularly adjusted relative to the second mounting part by a gear unit, the first mounting part being able to be adjusted in a first position and in a second position, the first mounting part and the second mounting part being locked to one another by a locking means such that a manually surmountable resistance is created, which makes it more difficult to swivel the first mounting part into the first position.

Such vehicle seats are generally known. For example, the published patent application DE 10 2004 021 673 A1 discloses a vehicle seat which comprises a longitudinally adjustable seat part and a backrest which may be swiveled via an articulation. In this connection, for simplifying access to the vehicle interior the backrest may be folded up onto the seat part and displaced forward together with the seat part. To this end, means are provided which influence the force required for folding back the backrest. A drawback with the above-mentioned means is the relatively complicated design, as well as the relatively high degree of accuracy required for positioning. As a result, the manufacture of such a vehicle seat is costly and time-consuming.

### SUMMARY

It was the object of the invention to provide a vehicle seat which does not have the drawbacks of the vehicle seats known from the prior art and yet has few components and a low weight. To achieve the object of the invention, a vehicle seat for a motor vehicle is proposed, comprising a first mounting part and a second mounting part, the first mounting part being swivelable relative to the second mounting part about a swivel axis, the vehicle seat comprising a gear unit, the first mounting part being able to be angularly adjusted relative to the second mounting part by the gear unit, the first mounting part being connected to a backrest of the vehicle seat and the second mounting part being connected to a seat part of the vehicle seat, the backrest of the vehicle seat in a first position being located substantially perpendicular to the seat part and upright, in a second position the backrest being swiveled about the swivel axis relative to the first position, the vehicle seat comprising a locking means with at least one locking surface, the first mounting part and the second mounting part in the second position being interlocked by means of the locking means such that a manually surmountable resistance is created, which makes it more difficult to swivel the backrest into the first position, and the locking surfaces of the locking means in the second position being arranged on top of one another, in a radial direction relative to the swivel axis. In the vehicle seat according to the invention, a coupling mechanism is preferably provided which releases the locking of the longitudinal displacement of the vehicle seat, as soon as the backrest is folded forward. As a result, a so-called “easy entry function” is produced, which allows the boarding of passengers onto the rear seat rows in a particularly easy manner. In the vehicle seat according to the invention it is possible in a simple manner, by means of the locking means according to the invention, to hold the backrest in a folded-forward position until the vehicle seat has again adopted its original position in the vehicle interior (relative to a longitudinal displacement) and only then to effect a folding up of the backrest (so-called “soft lock”). As a result, it is possible to transfer the vehicle seat in a defined manner—by simply pushing or pulling on the backrest—again into the original position, whereby the user comfort is increased and the operation is facilitated. The original seat part position of the vehicle seat (adopted before the displacement) is, for example, able to be set again by a so-called “memory device”.

Preferably, the design of the vehicle seat is provided such that the first mounting part or the second mounting part comprise a contact plate and a swivel part, the contact plate being directly connected to the gear unit and the swivel part being able to be unlocked or locked relative to the contact plate. Moreover, the swivel part is provided to be swivelable relative to the contact plate about the swivel axis. If the swivel part is locked to the contact plate, the angular adjustment which is produced by the gear unit may be transmitted to the swivel part. When unlocking the swivel part from the contact plate, in particular in the case of swiveling the swivel part relative to the contact plate, the angular adjustment is substantially no longer able to be transmitted to the swivel part by the gear unit. As a result of the angular adjustment it is advantageously possible to swivel and/or to incline the backrest for the vehicle passenger in a small angular range, for example ±10° relative to the seat part. As a result, the seating comfort is increased for the passenger. Such a small angular adjustment is unnecessary or undesirable with a backrest which has been folded up into the second position.

Further preferably, the locking means comprises a first part and a second part, both parts (first and second part) preferably having one respective locking surface. Accordingly, the locking means is constructed from two parts which may be locked to one another or unlocked from one another.

Particularly preferably, the first mounting part comprises the first part of the locking means and the second mounting part comprises the second part of the locking means. Preferably, one of the parts of the locking means is directly attached to the swivel part and may be swiveled therewith, when the mounting part is swiveled about the swivel axis into the second position. For example, it is possible that the first mounting part comprises the first part of the locking means in an internal edge region of the swivel part (the region which moves at a small distance around the gear unit when swiveling about the swivel axis). The second mounting part, however, comprises the second part of the locking means which is, for example, fixed and not rotatable about the swivel axis, at a short distance from the gear unit.

Moreover, both the first part of the locking means and the second part of the locking means have locking surfaces which are preferably formed substantially identically. It is particularly preferable, therefore, when not only the locking surfaces are formed identically but also the first part and the second part of the locking means are formed substantially identically. As a result, the manufacture of the two parts (first part and second part) of the locking means is particularly simple, as then both parts may be provided as identical parts, which leads to lower costs, namely for injection molds or for the logistics. Moreover, it is preferred if the locking surface forms a type of step with the further partial regions of the locking means, the step having a preferred width of 2 to 0.3 cm, particularly preferably of 1 to 0.3 cm, quite particularly preferably from 0.5 to 0.3 cm.

According to the invention, the first part of the locking means is preferably mirrored relative to the second part of the locking means about a mirror axis, which extends perpendicular to the longitudinal side of the locking means and is subsequently attached to the first mounting part, rotated by 180° about the swivel axis. By this specific attachment it is possible that the locking surface of the first part of the locking means and the locking surface of the second part of the locking means are locked to one another, if the first mounting part has been swiveled relative to the second mounting part about the swivel axis into the second position.

Preferably, the first part and/or the second part of the locking means is manufactured from plastics and is elastically deformable. By the elastic deformability it is possible that the two parts of the locking means are locked to one another without, as a result, damage occurring to the parts of the locking means. When swiveling the first mounting part about the swivel axis, the first part of the locking means is guided in a circular path about the gear unit. In this connection, the first part of the locking means strikes with its locking surface against the locking surface of the second part of the locking means. Preferably, at least the upper region of the second part of the locking means swivels outward easily, parallel to the swivel axis, by means of the pressure acting thereon (via the first part of the locking means). As a result, the first part of the locking means is displaced further along the circular path. By the partial swiveling of the second part parallel to the swivel axis, the two undersides of the locking surfaces of the two parts of the locking means come into contact with one another and are hooked together. Naturally, it is also conceivable that as a result of the pressure the second part of the locking means does not swivel partially parallel to the swivel axis, but the swiveling motion is carried out by the first part of the locking means. In the locked position of the two parts of the swivel means, according to the invention a manually surmountable resistance is created, as for swiveling the second mounting part (and thus also the backrest) initially the first and/or the second part of the locking means has to swivel parallel to the swivel axis, so that the two parts of the locking means and/or the locking surfaces are released from one another. When pushing back the vehicle seat into its original position, therefore, the user may longitudinally displace the vehicle seat (backrest and seat part) by pulling or pushing the backrest. The resistance which is created by the locking means is sufficient in order to prevent a folding back of the backrest into the first position by pushing or pulling on the backrest for longitudinal displacement. This means that the locking surfaces of the locking means remain substantially in contact with one another and are not unlocked by a swiveling motion of one of the parts of the locking means parallel to the swivel axis. Only after the vehicle seat has reached its original position in the longitudinal direction, i.e. force no longer has to be expended for the displacement in the longitudinal direction, is the resistance of the locking means surmounted, so that the backrest may be transferred into the first position. As a result, the resistance has to be adjusted such that it is sufficiently great in order to hold the backrest in the folded-up position during a longitudinal displacement of the vehicle seat (when pushing or pulling the backrest for longitudinal displacement), but on the other hand small enough in order to prevent an excessive force expenditure on the part of the user. The upper region of the locking means is preferably the region which contains the locking surface. By the term “original position”—or also the position of use—is intended to be understood the position when the backrest is located upright on the seat part (first position) and additionally the vehicle seat has not yet been longitudinally displaced in the direction of the rear window (or the longitudinal axis of the vehicle) (for simplifying the access to the rear row of seats).

In a further embodiment, preferably only the locking surface of the first part and/or the locking surface of the second part are manufactured from plastics and elastically deformable. As a result, it is possible to manufacture the overwhelming part of the locking means (i.e. the first and/or the second part) from a more rigid material, whereby wear of these components is reduced.

Preferably, the gear unit of the vehicle seat according to the invention is a wobble mechanism. As a result, the angular adjustment of the backrest in a comfort range (±10° inclination) is possible in a particularly simple manner.

Further preferably, the locking means in the second position is independent of the angular position of the first mounting part. As already disclosed, the movement for the angular adjustment may not be transmitted to the swivel part by the gear unit, if the swivel part is not locked to the contact plate. The swivel part thus does not move in the same manner as the contact plate, during a rotation of the gear unit. Nevertheless, in the unlocked state the swivel part is also moved with the contact plate in a small range, during a wobble motion of the gear unit. As a result of the design according to the invention of the locking surfaces of the locking means, however, such a motion may be compensated as the locking surfaces in this case move against one another. As a result of the motion, generally the entire locking surface of the first part is not in contact with the entire locking surface of the second part of the locking means. The contact surface is, however, sufficiently large in order to create the manually surmountable resistance. By means of the locking surfaces which interact with one another during the locking, it is additionally advantageously possible that a locking of the locking means takes place independently of a previously set angular position of the first mounting part. By a stepped design of the locking surface with a corresponding step width, in the manner already disclosed, the two locking surfaces may also then be interlocked, if the circular path of the first locking means (during the swivel motion thereof) has been slightly altered by the wobble motion by the gear unit. To this end, it is to be explained that the wobble mechanism has an eccentric rotational axis whereby the first mounting part (when it is in contact with the contact plate) is also angularly adjusted in an eccentric manner. With a subsequent swivel motion about the swivel axis, however, the circular motion which the first part of the locking means performs, may be easily varied by the previous eccentric motion (circular path about the swivel axis at a variable distance from the swivel axis). The locking surfaces of the locking means are, however, locked to one another by the selected step width, at the same time partial regions of the locking surfaces also not being able to be in contact with one another. The creation of the manually surmountable resistance is, however, provided as the overwhelming part of the locking surfaces are in contact with one another and for releasing the partial regions of the locking means only one of the parts has to be swiveled parallel to the swivel axis (by the upwards rotational movement about the swivel axis of the first mounting part) so that the surfaces may be released from one another.

### DRAWINGS

The invention is explained hereinafter with reference to embodiments shown in the drawings, the general inventive idea not being restricted.

FIG. 1 shows schematically the vehicle seat according to the invention in a first position.

FIG. 2 shows schematically the vehicle seat according to the invention in a second position, the vehicle seat additionally having been displaced in direction A.

FIG. 3 shows schematically a detailed view of the locking means according to the invention.

FIG. 4 shows schematically a first part and a second part of the locking means according to the invention, the two parts being locked to one another.

FIG. 5 shows schematically the second part of the locking means according to the invention with a step width and step height shown.

### DETAILED DESCRIPTION

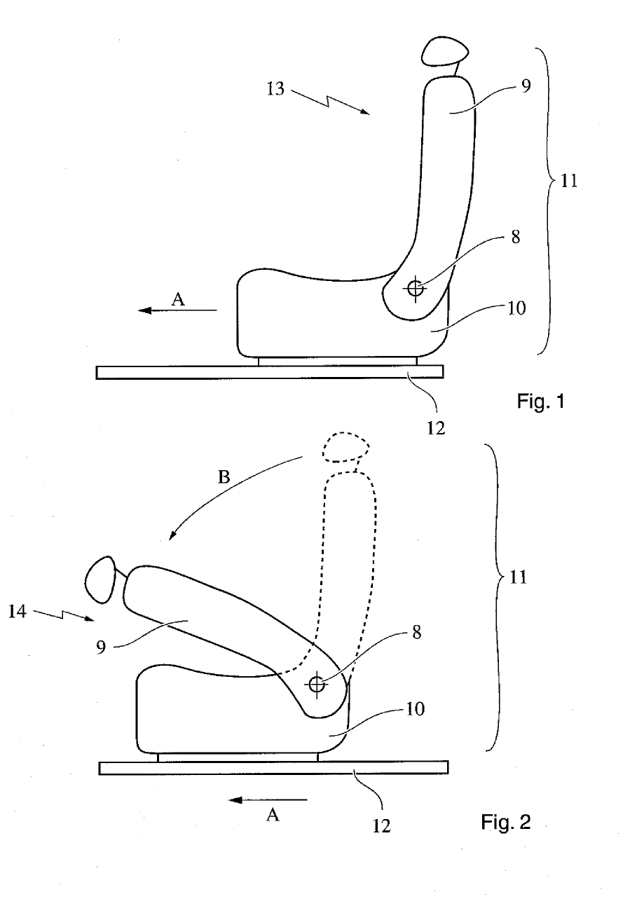

In FIG. 1 the vehicle seat 11 according to the invention is shown in a first position 13. In the first position 13 a backrest 9 is provided upright, the backrest 9 being connected to a seat part 10. The vehicle seat 11 is displaceable in direction A (preferably in the longitudinal direction of the vehicle), the displacement taking place via rails 12 only when a corresponding longitudinal adjustment mechanism has been released. As a result, it is prevented that the vehicle seat 11 moves in direction A, for example in a crash. For example, such a mechanism may only be released by transferring the backrest 9 into a second position 14 (not shown in FIG. 1).

FIG. 2 shows schematically the vehicle seat 11 in the second position 14. In the embodiment, therefore, the backrest 9 has been swiveled in direction B (relative to the seat part 10). The (original) position of the backrest 9 in the first position 13 is shown by dotted lines for the sake of clarity. However, it is also conceivable to swivel the backrest 9 in other ways, for example away from the seat part 10. After being transferred into the second position 14, the vehicle seat 11 has been displaced on the rails 12 in direction A. As a result, it is possible according to the invention to facilitate the boarding of passengers, who wish to sit on the rear seat bench.

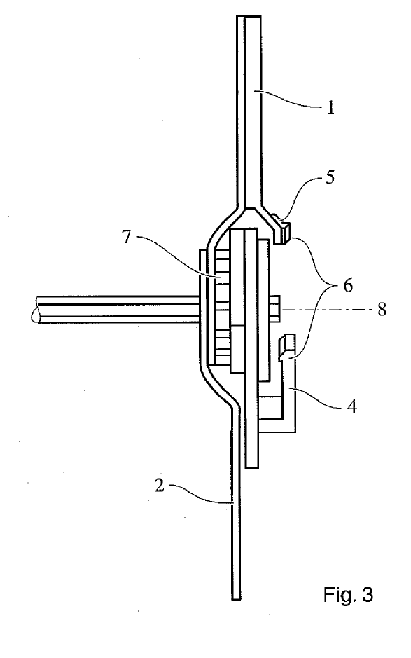

FIG. 3 shows schematically a detailed drawing of a locking means 6. The locking means 6 comprises in this embodiment a first part 5 and a second part 4. The first part 5 is arranged on a first mounting part 1. The second part 4, however, is attached to a second mounting part 2. Between the mounting parts 1, 2 is located a gear unit 7, which preferably is a wobble mechanism. In this connection it is also possible that the gear unit 7 is at least partially formed by the mounting parts 1, 2. It is possible to swivel the first mounting part 1 relative to the second mounting part 2 about the swivel axis 8. In this connection, the first part 5 of the locking means 6 and the second part 4 of the locking means 6 come into contact with one another with the locking surfaces 15, 15′ thereof (not shown in FIG. 3).

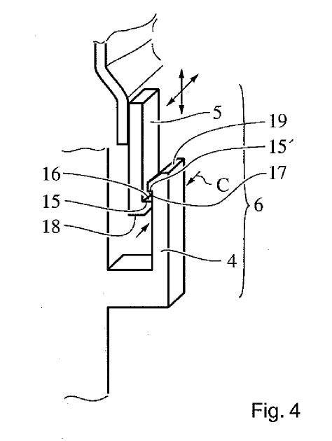

FIG. 4 shows schematically the locking means 6 in the locked view. For locking, initially the first mounting part 1 has been swiveled about the swivel axis 8, so that the first part 5 of the locking means 6 and the second part 4 of the locking means 6 strike one another. With a further rotational movement of the first mounting part 1 in the same direction, the upper face 18 of the first part 5 presses against the upper face 19 of the second part 4 of the locking means 6. The pressure produced by the rotational movement, which acts on the locking surfaces 15, 15′, has the result that one part 5, 4 or both parts 5, 4 of the locking means 6 yields and/or yield parallel to the swivel axis 8. As a result, with a further small rotational movement about the swivel axis 8 the locking surfaces 15, 15′ are pushed against one another such that the lower region 17 (also denoted as the underside) of the second part 4 comes at least partially into contact with the underside 16 of the first part 5 of the locking means 6. By means of the step-like design, with a corresponding step width C of the locking means 6, the locking surfaces 15, 15′ may also still be locked to one another when the circular path of the first part 5 of the locking means 6 has been altered by an eccentric angular motion (by the gear unit 7). In this case, the entire locking surfaces 15, 15′ would not be in contact with one another but only partial regions of the locking surfaces 15, 15′. By means of the locking surfaces 15, 15′ additionally the first part 5 and the second part 4 are able to be displaced relative to one another by the step width C, so that movements of one of the two parts 4, 5 or both parts 4, 5 of the locking means 6 in the locked position do not lead to a release of the locking.

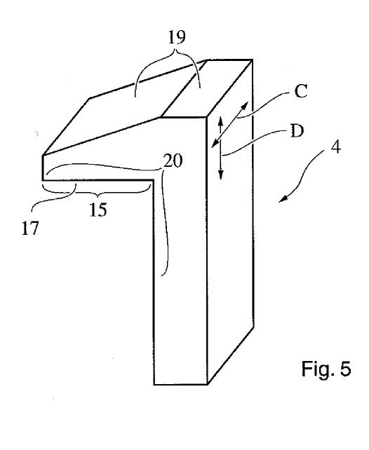

In FIG. 5, the second part 4 of the locking means 6 is shown schematically. With a rotational movement of the first mounting part 1 about the swivel axis 8, the upper face 19 or partial regions of the upper face 19 of the second part 4 strike the upper face 18 of the first part 5. After the yielding of one of the two parts 4, 5 parallel to the swivel axis 8, the locking surface 15 of the second part 4 comes into contact with the locking surface 15′, not shown, of the first part 5 of the locking means 6. The step 20 already disclosed above is formed by the locking surface 15 and a further region of the second part 4 of the locking means 6. By the selected step width C, a tolerance compensation results relative to the region in which the two locking surfaces 15, 15′ come together. The two locking surfaces 15, 15′ do not have to be in contact over the entire step width C. It is sufficient if partial regions of the locking surfaces 15, 15′ are in contact with one another in order to create a resistance according to the invention. As a result, an eccentric angular adjustment of the first mounting part 1 may be compensated. The step height D may be varied, in order to alter the rigidity of the two parts 4, 5 of the locking means 6 and, in particular, to adjust the resistance against a release of the locking.

1. A vehicle seat for a motor vehicle, comprising a first mounting part and a second mounting part, the first mounting part being swivelable relative to the second mounting part about a swivel axis, the vehicle seat comprising a gear unit, the first mounting part being able to be angularly adjusted relative to the second mounting part by the gear unit, the first mounting part being connected to a backrest of the vehicle seat and the second mounting part being connected to a seat part of the vehicle seat, the backrest of the vehicle seat being located in a first position substantially perpendicular to the seat part and substantially upright, in a second position the backrest being swiveled about the swivel axis relative to the first position, the vehicle seat comprising a locking means with at least one locking surface, the first mounting part and the second mounting part in the second position being interlocked by means of the locking means such that a manually surmountable resistance is created, increasing a difficulty of swiveling the backrest into the first position, wherein two locking surfaces of the locking means are arranged in the second position on top of one another, in a radial direction relative to the swivel axis.

2. The vehicle seat as claimed in claim 1, wherein the first mounting part or the second mounting part comprises a contact plate and a swivel part, the contact plate being directly connected to the gear unit, the swivel part being able to be unlocked and locked relative to the contact plate, and the swivel part in the unlocked state being swivelable relative to the contact plate about the swivel axis.

3. The vehicle seat as claimed in claim 1, wherein the locking means comprises a first part and a second part.

4. The vehicle seat as claimed in claim 3, wherein the first mounting part comprises the first part of the locking means and in that the second mounting part comprises the second part of the locking means.

5. The vehicle seat as claimed in claim 3, wherein locking surfaces of the first part and of the second part of the locking means are substantially identical.

6. The vehicle seat as claimed in claim 3, wherein the first part of the locking means is mirrored relative to the second part of the locking means about a mirror axis, which extends perpendicular to the longitudinal side of the locking means, and is subsequently attached, rotated by 180° about the swivel axis.

7. The vehicle seat as claimed in claim 3, wherein the first part and/or the second part of the locking means is made of a plastic material and is elastically deformable.

8. The vehicle seat as claimed in claim 3, wherein the first part and/or the second part of the locking means is formed in one piece with the mounting parts.

9. The vehicle seat as claimed in claim 3, wherein locking surfaces of the first part and/or of the second part of the locking means is made of a plastic material and is elastically deformable.

10. The vehicle seat as claimed in claim 1, wherein the gear unit is a wobble mechanism.

11. The vehicle seat as claimed in claim 1, wherein the locking means in the second position is locked by the gear unit independently of angular position.
